(19) United States
(12) Patent Application Publication
(10) Pub. No.: US 2020/0385609 A1
(43) Pub. Date: Dec. 10, 2020

(54) ICE-PHOBIC COATINGS

(71) Applicants: DOW GLOBAL TECHNOLOGIES LLC, Midland, MI (US); DOW SILICONES CORPORATION, Midland, MI (US)

(72) Inventors: Yu CHEN, Shanghai (CN); Xiaomei SONG, Shanghai (CN); Guodong SHEN, Shanghai (CN); Wenjie CHEN, Shanghai (CN); Hongyu CHEN, Shanghai (CN)

(21) Appl. No.: 16/634,835

(22) PCT Filed: Jul. 31, 2017
(86) PCT No.: PCT/CN2017/095149

§ 371 Date: Jan. 28, 2020

(51) Int. Cl. C09D 183/04; C09D 7/65; C09D 7/40; C09D 7/61

(52) U.S. Cl. CPC C09D 183/04; C09D 7/65; B01J 23/42; C09D 7/61; C09D 7/69

(57) ABSTRACT

A coating composition which provides a coating with a very low adhesion to ice is disclosed. The coating composition contains a cross-linked silicone binder resin and an elastomeric silicone powder.

### CROSS-REFERENCE TO RELATED APPLICATIONS

This application is the National Stage of International Appl. No. PCT/CN2017/095149 filed on 31 Jul. 2017, the content of which is incorporated herein by reference.

### FIELD

The present invention relates generally to a coating composition which provides a coating with a very low adhesion to ice. The coating composition comprises a cross-linked silicone binder resin and an elastomeric silicone powder.

### INTRODUCTION

Icing (ice build-up on an article) in a cold environment causes problems for many applications, including rotors and blades of wind turbines, power lines, telecommunications, transportations, air crafts and housewares such as refrigerators, freezer box and ice tray. Such ice build-up may be removed by heating, by applying chemicals that reduce the melting point of ice, by applying a mechanical force or by occluding air to break the bonding between ice and the surface of an article. However, all of these methods have limitations and disadvantages. An alternative method to prevent ice build-up on an article is to protect the surface of the article with a coating that has a very low ice adhesion strength (i.e. ice barely adheres to the coating). Such coating is called as “ice-phobic coating”. Some prior art references disclose an ice-phobic coating on the surface of articles, for example, US2015/0361319A, WO2016/176350A, WO2015/119943A, US9,388,325B and US2010/0326699.

### SUMMARY

The present invention provides a coating composition which shows very low adhesion to ice.

One aspect of the invention relates to a coating composition comprising (A) a silicone resin, (B) a silicone powder, (C) a catalyst and (D) a solvent, wherein the weight ratio of the silicone resin over the silicone powder ((A)/(B)) is from 2.5 to 200.

In another aspect, the invention relates to a coating film formed from the composition mentioned above.

In yet another aspect, the invention relates to an article having a film at least a part of the surface of the article, wherein the film is formed from the composition mentioned above.

In yet further aspect, the invention relates to a coating composition comprising (A) 10 to 45 weight % of a silicone resin, (B) 0.1 to 7.5 weight % of a silicone powder, (C) 10 to 250 ppm of a catalyst and (D) 30 to 80 weight % of a solvent.

### DETAILED DESCRIPTION

The coating composition of this invention comprises (A) a silicone resin, (B) a silicone powder, (C) a catalyst and (D) a solvent.

(A) Silicone Resin

Silicone resin used in the coating composition is a crosslinked polysiloxane polymer, and works as a matrix polymer in the coating composition. The silicone resin is also called as ‘binder resin’ or ‘matrix resin’. The silicone resin is typically formed by crosslinking of a trifunctional siloxane with other trifunctional siloxanes or difunctional siloxanes. In some embodiments, the silicone resin can be formed by the crosslinking of a monomer mixture, wherein the monomer mixture is polyvinyl terminated polydimethylsiloxane, a polymethylvinyl terminated polydimethylsiloxane, a methylhydrogen siloxane and tetramethyl tetravinyl cyclotetrasiloxane. More specifically, suitable examples of the silicone resin are methyl silyl and silanol terminated poly silsesquioxane; trimethyl silyl and dimethyl vinyl silyl terminated poly silsesquioxane; organopolysiloxane represented by the following formula: [MeSiO_{3/2}]ₐ[Me₂SiO]_{b}[RO_{1/2}]_{c}, a+b=1, c<2; organopolysiloxane represented by the following formula:

[SiO₂]ₐ[Me₃SiO_{1/2}]_{b}[Me₂VinylSiO_{1/2}]_{c}[HO_{1/2}]_{d},a+b+c=1,a:(b+c)=0.7˜1,b:c=1˜4,d<0.05

and a mixture of the said two resins with poly dimethyl siloxane or poly vinylmethyl siloxane. The silicone resin is typically formulated as either 1-component or 2-component silicone composition. The silicone resin may be cross-linked during the curing process.

The amount of silicone resin in the coating composition is from 10 to 45 weight %, preferably from 15 to 40 weight % based on the weight of the coating composition.

(B) Silicone Powder

Silicone powder used in the coating composition is an elastomeric silicone powder and it dramatically reduces the ice adhesion strength of the surface of the coating. Inventors of this invention found that soft hydrophobic powder can help to reduce the ice adhesion strength of the surface of the coating rather than hard powders such as inorganic powders. Not bound to the theory but it is considered that such soft hydrophobic powder can adjust the surface modules of the coating and creates phase separation in micro scale. In addition, since silicone powder is compatible to the silicone matrix resin and the density of silicone powder is similar to the density of silicone matrix resin, silicone powder can be easily dispersed in the silicone matrix resin and forms a stable coating composition.

The hardness of the silicone powder is preferably Shore A 80 or less, more preferably Shore A 60 or less, the most preferably Shore A 40 or less. The hardness of silicone powder can be analyzed by Shore Durometer.

The particle size (average particle size) of the silicone powder is preferably from 0.1 to 20 micrometers, more preferably from 1 to 10 micrometers. The particle size of silicone powder can be analyzed by Laser particle analyzer.

The density of the silicone powder is preferably from 0.1 to 0.7 g/cm³, more preferably from 0.2 to 0.5 g/cm³. The density of silicone powder can be analyzed by 50 ml volumeter.

The amount of silicone powder in the coating composition is from 0.1 to 7.5 weight %, preferably from 0.2 to 5 weight %, more preferably from 0.5 to 2 weight % based on the weight of the coating composition. When the coating composition is applied on an article and forms a film, solid contents of the coating composition are remained in the film. So the amount of silicone powder in the solid contents of the composition is from 0.5 to 37.5 weight %, preferably from 1 to 25 weight %, more preferably from 2.5 to 10 weight % based on the weight of the solid contents.

The weight ratio of silicone resin over silicone powder is from 2.5 to 200, preferably from 4 to 100, more preferably from 10 to 40.

(C) Catalyst

Catalyst used in the coating composition of the invention is a catalyst for crosslinking of silicone matrix resin. Any known catalyst can be used. Examples of such catalyst include, but are limited to, platinum compound such as chloroplatinic acid and platinum(0)-1,3-divinyl-1,1,3,3-tetramethyldisiloxane complex, palladium compound such as palladium(II) chloride and allylpalladium(II) chloride, zirconium compound such as zirconium octoate and zirconium acetate, titanium compound such as titanium(IV) butoxide and zinc compound such as zinc octoate and zinc acetate.

The amount of catalyst in the coating composition should be sufficient to crosslink silicone matrix resin, but typically is from 4 to 400 ppm, preferably from 10 to 250 ppm based on the weight of the coating composition.

(D) Solvent

The coating composition comprises a solvent. Examples of solvent include, but are not limited to, alcohols, esters, ethers, ketones, ether-alcohols, aromatic hydrocarbons, aliphatic hydrocarbons, halogenated hydrocarbons and volatile silicones.

The amount of solvent in the coating composition is from 10 to 90 weight %, preferably from 30 to 80 weight % based on the weight of the coating composition.

(E) Filler

The coating composition of the invention can optionally include filler in addition to silicone powder. Examples of such filler include, but are not limited to, inorganic particles such as silica and metal oxides, and polymer particles such as dry latex powder and polyvinyl alcohol powder. The particle size of the filler is, preferably from 1 to 50 micrometers, more preferably from 1 to 10 micrometers. When the coating composition comprises such filler, the amount is from 0.1 to 1 weight %, preferably from 0.2 to 0.5 weight % based on the weight of the coating composition.

(F) Silicone Fluid

The coating composition of the invention can optionally include silicone fluid. Silicone fluid helps to reduce the ice adhesion strength of the surface of a coating. Examples of such silicone fluid include, but are not limited to, trimethyl silyl terminated poly dimethyl siloxane, silanol terminated poly dimethyl siloxane and dimethylhydrogen silyl terminated poly dimethyl siloxane. Viscosity of the silicone fluid is preferably from 50 to 500 centistokes, more preferably from 100 to 350 centistokes. When the coating composition comprises such silicone fluid, the amount is from 1 to 20 weight %, preferably from 5 to 10 weight % based on the weight of the coating composition.

Other Ingredients

The coating composition of the invention can include other ingredients such as surfactant, wetting agent and dye, these are known to those skilled in the art.

Article and Coating Film

The coating composition is applied on an article and form a film at least a part of the surface of the article. Variety of techniques can be used such as splaying, brushing roller, dip coating, spin coating, wire coating and the like. Then, typically the article is heated to cure the composition on the surface of the article. Conditions such as temperature or heating time are vary and are known to those skilled in the art. Thickness of the film is preferably from 1 to 80 micrometers, more preferably from 15 to 60 micrometers.

Examples of such article include, but are not limited to, ice maker, fridge, condenser and air conditioner.

### EXAMPLES

The raw materials disclosed in Table 1 were used to prepare samples in Examples.

TABLE 1

| Material Type | Description | Supplier |
|---|---|---|
| A1 (including | 2 part composition for silicone dielectric | Dow |
| (C)) | gel, comprising vinyl polymer, siloxane | Corning |
| | crosslinker and Pt catalyst | |
| A2 (including | 2 part composition for silicone elastomer, | Dow |
| (C)) | comprising vinyl polymer, vinyl terminated | Corning |
| | silicone resin, siloxane crosslinker and Pt | |
| | catalyst | |
| A3 (including | Silicone resin coating comprising methyl | Dow |
| (C) and (D)) | silicone resin, silanol terminated PDMS, | Corning |
| | catalyst and solvents. | |
| F1 | Dimethyl hydrogen silyl capped | Dow |
| | polydimethyl siloxane | Corning |
| B1(including | A mixture of dimethicone/vinyl dimethicone | Dow |
| (D) and (E)) | crosspolymer and silica in butylene glycol, | Corning |
| | average particle size 3-10 micrometers, | |
| | density 0.2-0.5 g/cm³, hardness is Shore | |
| | A40 | |
| B2 | Cross-linked epoxy functional silicone | Dow |
| | elastomer powder, average particle size | Corning |
| | is 2 micrometers, particle size distri- | |
| | bution is from 1 to 10 micrometers, | |
| | density is 0.18 g/liter, epoxy equivalent | |
| | is 5,000 | |
| E1 | Vinyl acetate and ethylene based polymer | Wacker |
| | powder, particle size max. 4% over 400 | |
| | μm density 490-590 kg/m³, hardness ~S | |
| E2 | Fumed silica, BET: 175-225 m²/g | Wacker |
| E3 | Mesoporous silica, particle size is | Sigma |
| | 15 micrometer or less | Aldrich |
| E4 | Precipitated CaCO₃, particle size is | Neolight |
| | 0.04-0.2 micrometers | |
| E5 | Carbon black, average diameter is 35 nm | Denka |
| D1 | Heptane | Wokai Co. |
| F2 | Silicone fluid, 100 cst | Dow |
| | | Corning |
| F3 | Silicone fluid, 350 cst | Dow |
| | | Corning |
| — | Silicone vinyl gum | Dow |
| | | Corning |

### Examples 1 to 11

The law materials listed in Tables 2 and 3 were homogeneously mixed by shaking for 30 minutes at room temperature. 0.6 ml of each solution was blade coated on an aluminum panel and heated to cure the composition, at 150 degrees C. for 1 hour for the composition listed in Table 2, at 200 degrees C. for 1 hour for the composition listed in Table 3. Dry film thickness was analyzed by Ultrasonic thickness gauge (zenotip).

Ice Adhesion Testing Method:

Prepared plastic caps (diameter is 4.3 cm) and aluminum plates. The plastic cap is put on the aluminum plate, then the plate with the plastic cap was cooled to form ice on the surface of the aluminum plate under −20 degrees C. for 24 hours. The plate with plastic cap was fixed by a clamp in environmental chamber set at −20 degrees C. The cap was pushed by a metal probe in parallel direction with the plate surface, with speed of 1 mm/minutes. The maximum force (F.N) was recorded to isolate the cap from the surface of the plate. Then ice adhesion strength was calculated by the following equation: t=F/1.45 (kPa)

The result are also added in Tables 2 and 3.

TABLE 2

| | Examples | | | | | |
|---|---|---|---|---|---|---|
| Coating composition | 1 (control) | 2 | 3 | 4 | 5 | 6 |
| A1-Part1 | 8 | 8 | 8 | 8 | 8 | 8 |
| A2-part1 | 25 | 25 | 25 | 25 | 25 | 25 |
| D1 | 30 | 30 | 30 | 30 | 30 | 21 |
| A1-part2 | 0 | 0 | 0 | 0 | 0 | 0 |
| A2-Part2 | 0.15 | 0.15 | 0.15 | 0.15 | 0.15 | 0.15 |
| D1 | 22.85 | 22.85 | 22.85 | 22.85 | 22.85 | 22.85 |
| F1 | 3 | 3 | 3 | 3 | 3 | 3 |
| B1 | 0 | 0.5 | 1 | 2 | 5 | 10 |
| F3 | 12 | 12 | 12 | 12 | 12 | 12 |
| Dry Film thickness, | 30 | 30 | 30 | 30 | 30 | 30 |
| (micrometers) | | | | | | |
| Ice adhesion (kPa) | 8 | 4 | 0.5 | 4 | 5 | 7 |
| Resin/ | 00 | 48 | 24 | 12 | 4.8 | 2.5 |
| Powder ratio | | | | | | |

TABLE 3

Examples

| Coating composition | 7 | 8 | 9 | 10 | 11 |
|---|---|---|---|---|---|
| A3 | 0 | 100 | 95 | 95 | 95 |
| B1 | 0 | 0 | 1 | 0 | 1 |
| Silicone vinyl gum | 0 | 0 | 0 | 0.05 | 0.05 |
| F1 | 0 | 0 | 0 | 0.05 | 0.05 |
| D1 | 0 | 0 | 4.9 | 4.9 | 4.9 |
| Dry Film thickness | 0 | 15 | 15 | 15 | 15 |
| (micrometers) | | | | | |
| Ice adhesion (kPa) | 90 | 30 | 10 | 18 | 1 |
| Resin/Powder ratio | NA | ∞ | 18 | ∞ | 18 |

Comparing to aluminum panel without a coating (the ice adhesion is around 90 kPa), all the silicone rubbery coating reduce the ice adhesion significantly. The low silicone powder containing coating (Ex. 2) show very low ice adhesion compared to no or high silicone powder containing coatings (Ex. 1, Ex. 3), which demonstrate the effects of this surface modulus modifier.

In a similar cases, silicone resin based hard coating was used as a binder. By comparison with SR2472 along (Ex. 8), silicone powder (Ex. 9) can reduce the ice adhesion by 97%. Ex. 11 shows another example with silicone powder added in the hard coating binder together with SiH silicone oil and vinyl gum to improve the surface gloss and hand feeling. Compared to Ex. 10, which contained no silicone powder, Ex. 11 demonstrate low ice adhesion as in Ex. 9.

### Examples 12 to 15

The formulation listed Table 4 were tested. Other particles are used instead of EP9801 used in Example 9.

TABLE 4

Examples

| | 12 | 13 | 14 | 15 |
|---|---|---|---|---|
| A3 | 99 | 99 | 99 | 99 |
| B2 | 1 | 0 | 0 | 0 |
| E1 | 0 | 1 | 0 | 0 |
| E2 | 0 | 0 | 1 | 0 |
| E3 | 0 | 0 | 0 | 1 |
| Dry film thickness | 15 | 15 | 15 | 15 |
| (micrometers) | | | | |
| Ice adhesion (kPa) | 1.7 | 6 | 32 | 20 |
| Resin/Powder ratio | 18 | 18 | 18 | 18 |

1. A coating composition comprising:
(A) a silicone resin;
(B) a silicone powder;
(C) a catalyst; and
(D) a solvent;
wherein the weight ratio of the silicone resin to the silicone powder ((A)/(B)) is from 2.5 to 200.

2. The coating composition of claim 1, wherein the hardness of the silicone powder is Shore A 80 or less.

3. The coating composition of claim 1, wherein the particle size of the silicone powder is from 1 to 10 micrometers.

4. The coating composition of claim 1, wherein the density of the silicone powder is from 0.2 to 0.5 g/cm³.

5. The coating composition of claim 1, wherein the silicone resin is selected from the group consisting of methyl silicone resin, silanol terminated polydimethylsiloxane and non-functional polydimethylsiloxane.

6. The coating composition of claim 1, further comprising (E) a filler.

7. The coating composition of claim 1, further comprising (F) a silicone fluid.

8. The coating composition of claim 1, wherein the catalyst is a zirconium catalyst or a platinum catalyst.

9. A coating film formed from the coating composition of claim 1.

10. An article having a surface and a film disposed on at least a portion of the surface, wherein the film is formed from the coating composition of claim 1.

11. A coating composition comprising:
(A) 10 to 45 weight % of a silicone resin;
(B) 0.1 to 7.5 weight % of a silicone powder;
(C) 10 to 250 ppm of a catalyst; and
(D) 30 to 80 weight % of a solvent.
